(19) United States
(12) Patent Application Publication
(10) Pub. No.: US 2003/0184679 A1
(43) Pub. Date: Oct. 2, 2003

(54) Method, apparatus, and program for providing slow motion advertisements in video information

(76) Inventor: Joseph Patrick Meehan, Dublin (IE)

Correspondence Address: PHILIPS INTELLECTUAL PROPERTY & STANDARDS, P.O. BOX 3001, BRIARCLIFF MANOR, NY, 10510, US

(21) Appl. No.: 10/108,455

(22) Filed: Mar. 29, 2002

(51) Int. Cl. H04N 9/74

(52) U.S. Cl. 348/565; 348/584

(57) ABSTRACT

A method for displaying video information, and a program and apparatus that operate in accordance with the method. The method comprises the steps of combining first and second video information to form combined video information. The first and second video information represents first and second video frames, respectively. At least one first program segment is represented by a first number of the first video frames, at least one second program segment is represented by a second number of the second video frames, and the first and second numbers are predetermined to correspond to first and second predetermined frame display rates, respectively. The method also comprises a step of displaying at least a portion of at least one of the first and second program segments represented by the combined information, at one of the first and second predetermined frame display rates.

### BACKGROUND OF THE INVENTION

1. Field of the Invention

This invention relates generally to advertisements included in media information, and in particular to a method, apparatus, and program for providing slow motion advertisements in video information.

2. Related Art

Video recorders/players (also referred to hereinafter collectively as “video recorders”) and other devices that modify and/or record the content of broadcast video are becoming increasingly popular. Examples of such devices include personal video recorders that automatically record programs on a hard disk, such as Digital Versatile Disk (DVD) recorders, and videocassette recorders (VCRs) that automatically record programs on a videocassette tape, based on preferences of a user. Such devices enable users to view recorded programs at a desired time, and also enable users to search through recorded programs while the programs are being presented on a display during a playback mode by, for example, selecting a fast forward or rewind key. For example, in the case of VCRs, components such as a capstan and tape reels of a transport system in which a videocassette tape is loaded are driven in either forward or reverse modes (depending on whether a forward or reverse search has been initiated) at a greater rate of speed than that employed during a normal, non-search playback mode, for advancing or reversing the tape at a corresponding rate of speed. In the case of DVDs, search operations are performed by moving a sled mechanism on which an optical device is mounted at a greater rate of speed than that employed during a normal, non-search playback mode, to enable the optical device to quickly scan across a rotating video disc being read, in a direction which depends on the type of search being performed. In either case, assuming that the contents of the videocassette tape or video disc being read are being presented on a display screen during the search operation, the contents are presented at a predetermined frame rate (e.g., 72 frames per second) which is greater than that (e.g., 24 frames per second) used during the normal, non-search playback mode. As can be appreciated by one skilled in the art, that greater frame rate corresponds to the increased speeds of movement of the relevant mechanical components of the video recorder used during the search operation(s).

Viewers often exploit the search capabilities of video recorders by invoking them to avoid having to endure viewing commercial advertisements, which may be recorded on an applicable recording medium (e.g., disc, videocassette tape, or other type of medium) being read, presented at the normal, playback rate of speed (frame rate) (e.g., 24 frames per second). As a notorious example, viewers often fast forward through advertisements recorded before other programs at the beginning of videocassette tapes. As a result, even though a viewer actually may be paying greater attention to the video display screen during such a search operation (in order to be ready to visually identify a desired program), the advertisements will be presented at a frame rate which is substantially greater than the normal, playback rate, and, as a result, the advertisements are not presented to the viewer in their intended form (video recorders also typically disable any associated audio sounds during such searches). There is a need, therefore, to overcome the foregoing problem by providing a technique which enables an advertisement recorded on a recording medium to be presented to a viewer in its intended form, even though a forward or reverse search through the contents of the recording medium may be being performed, and which therefore takes advantage of the greater attention often paid by viewers to video screens during such search operations.

### SUMMARY OF THE INVENTION

It is an object of this invention to provide a method, apparatus, and program which enable predetermined content, such one or more commercial advertisements, to be presented to a viewer while an automatic search operation is being performed by a video recorder through contents stored on a recording medium.

It is another object of this invention to provide a method, apparatus, and program for providing a slow-motion advertisement in video information to be presented to a user.

It is a further object of this invention to provide a method, apparatus, and program which enable an advertisement recorded on a recording medium to be presented to a viewer in its intended form, even though a forward or reverse search through the contents of the recording medium may be being performed.

Further objects and advantages of this invention will become apparent from a consideration of the drawings and ensuing description.

The foregoing objects of the invention are realized by a method for displaying video information, and a program and apparatus that operate in accordance with the method. The method comprises the steps of combining first and second video information to form combined video information. The first and second video information represents first and second video frames, respectively. At least one first program segment is represented by a first number of the first video frames, at least one second program segment is represented by a second number of the second video frames, and the first and second numbers are predetermined to correspond to first and second predetermined frame display rates. The method also comprises a step of displaying at least a portion of at least one of the first and second program segments represented by the combined information, at one of the first and second predetermined frame display rates.

The second predetermined frame display rate (e.g., 72 frames per second) corresponds to a search mode in which an information appliance, such as a VCR, DVD player, or other type of video recorder/player, performs a forward or reverse search of content stored in a corresponding storage medium (e.g., a videocassette, video disc). The first predetermined frame display rate (e.g., 24 frames per second) corresponds to a playback mode in which the information appliance causes stored content to be retrieved/read from the storage medium and presented on a display at a non-search frame display rate.

At least one of the first and second program segments preferably relates to an advertisement to be presented to a viewer upon the displaying of the combined information, although in other embodiments of the invention, those segments may relate to other types of programs, and may or may not be different from one another.

In accordance with an aspect of this invention, the combining step is performed to enable the content of the second video frames to be displayed during the displaying step as (a) a complete overlay of content of corresponding ones of the first video frames, or (b) within a Picture-In-Picture (PIP) sub-screen inserted corresponding ones of the first frames. In either case, if the combined information is displayed at the second predetermined frame display rate, which would occur in response to, for example, a user operating an information appliance to invoke the search mode, the program segments represented by the second video frames are presented to a viewer in their intended form, even though the search is performed at a higher speed than that used during the playback mode.

In accordance with one embodiment of the invention, the combining step is performed with a broadcast station, and the combined information is broadcast from that station to one or more receiving destinations, such as one or more of the information appliances. Within each individual information appliance, the displaying step may be invoked at some time later in response to, for example, a user invoking a search mode of the information appliance.

In accordance with another embodiment of the invention, the combining step is performed within individual information appliances in response to the search mode being invoked. In this embodiment, the first and/or second video information may be either pre-stored in the individual information appliances, prior to the combining step, or be combined as it is being received in real time from the broadcast station.

### BRIEF DESCRIPTION OF THE DRAWINGS

The present invention will be more readily understood from a detailed description of the preferred embodiments taken in conjunction with the following figures:

FIG. 1 is a block diagram of a hardware system 1 that is suitable for practicing this invention, wherein the system 1 comprises a transmitter station 2 and at least one user information appliance 4 that are constructed and operated in accordance with this invention, and which are coupled together through an interface 30, and wherein the system 1 also comprises a video display apparatus 44 coupled to the user information appliance 4 through an interface 41.

FIG. 2 is a logical flow diagram of a method in accordance with one embodiment of this invention.

FIG. 3 is a logical flow diagram of a method in accordance with another embodiment of this invention.

FIGS. 4a and 4b show perspective views of the manner in which video frames 13′ including predetermined content, such as commercial advertisement subject matter, are overlaid on or inserted in, respectively, other corresponding video frames 12′, during the performance of the methods shown in FIGS. 2, 3, and 9.

FIGS. 5a-5c show examples of frames of information 11-13, respectively, employed during the performance of the methods of FIGS. 2, 3, and 9, wherein a program segment represented by the information 13 is spread out over a greater number of frames than are comparable individual program segments represented by frames of each information 11 and 12.

FIG. 6 represents the manner in which various components 10-13 in the transmitter station 2 of FIG. 1 operate to enable combining operations to be performed during the method of FIG. 2.

FIGS. 7 and 7b represent the manner in which various components in the transmitter station 2 and information appliance 4, respectively, of FIG. 1 operate to enable combining operations to be performed, during the method of FIG. 3.

FIG. 8 represents the combining of broadcast information 103 with slow-motion information 13 stored in a storage device 106, in accordance with a method of this invention shown in FIG. 9.

FIG. 9 is a logical flow diagram of a method in accordance with a further embodiment of this invention.

Identically labeled elements appearing in different ones of the figures refer to the same elements but may not be referenced in the description for all figures.

### DETAILED DESCRIPTION OF THE PREFERRED EMBODIMENTS

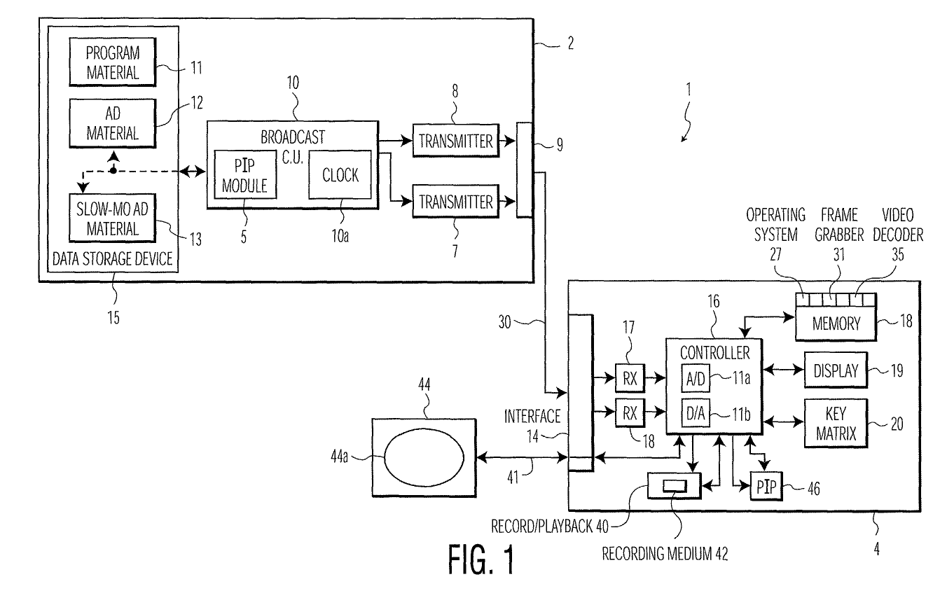

FIG. 1 is a block diagram showing an example of a hardware system 1 that is suitable for practicing this invention. In the illustrated embodiment, the system 1 comprises a transmitter station 2, at least one user information appliance 4, and a video display apparatus 44 for displaying video information, such as a conventional television receiver, although the apparatus 44 may include one or more other types of video display apparatuses instead, depending on the application of interest. The user information appliance 4 and video display apparatus 44 also are collectively referred to herein as a receiving station or a user information terminal 43. The transmitter station 2 and information appliance 4 are communicatively coupled to one another through an interface 30, and the information appliance 4 and video display apparatus 44 are communicatively coupled to one another through an interface 41. The interfaces 30 and 41 each may include various types of interfaces or interconnecting equipment for coupling the respective transmitter station 2 or video display apparatus 44, as the case may be, to the information appliance 4, such as, for example, one or more wires, cables, switches, routers, optical fibers, a wireless interface, and/or one or more networks (e.g., the Internet and/or other, proprietary network(s)), modems, and/or other suitable types of communication interfaces, depending on applicable system design and operating criteria, although, for convenience, no such equipment is shown in FIG. 1.

The individual information appliance 4 may include, for example, a PC, a personal video recorder (PVR), a VCR, a DVD recorder or some other type of digital video recorder (DVR), and the like, although other suitable types of user information appliances also may be employed. Although only a single transmitter station 2, a single user information appliance 4, and a single video display apparatus 44 are shown in FIG. 1, the number and variety of user information appliances 4 that may be in communication with the transmitter station 2 and video display apparatus 44 can vary widely, as can the number of transmitter stations 2 and video display apparatuses 44 that are in communication with individual user information appliances 4, depending upon, for example, user needs and geographic location(s), applicable system design and operating criteria, etc. It should be noted that the teaching of this invention is not to be construed as being limited for use only with a particular type of transmitter station, information appliance, or video display apparatus. In general, the teaching of this invention may be employed in conjunction with any suitable type of devices that are capable of receiving, displaying, recording and/or otherwise processing video information.

The transmitter station 2 preferably comprises a controller 10 which controls the overall operations of the transmitter station 2, one or more associated data storage devices 15 that are bidirectionally coupled to the controller 10, at least one communication interface 9, and, according to one embodiment of the invention, transmitters 7 and 8 that are coupled to the controller 10. The interface 9 couples the transmitters 7 and 8 to one or more external interfaces, such as the interface 30 and any other interfaces (not shown) to which the transmitter station 2 may be coupled, for enabling the transmitter station 2 to transmit information to external destination devices (e.g., information appliance 4) coupled those interfaces, although for convenience, only the external interface 30 and appliance 4 are shown. That information may include signaling information in accordance with the applicable external interface standard employed, video information, and other data.

The transmitters 7 and 8 each operate in a known manner by converting a signal received from the controller 10 to a predetermined frequency, if necessary depending on applicable operating criteria, and then transmitting the converted signal over one or more associated channels. Although two transmitters 7 and 8 are shown in the station 2 of FIG. 1, in other embodiments more or less than that number of transmitters may be included in the station 2, depending on, for example, applicable system architecture requirements, the number of transmission channels employed, etc. Also, although no D/A or A/D converters or encoders/decoders are shown in the transmitter station 2 of FIG. 1, such components may be included in that station 2 to convert signals from one form to another desired form before the signals are transmitted from the station 2, depending on, for example, for example, the type of external interface 30 employed and applicable operating criteria, as would be readily appreciated by one skilled in the art in view of this description.

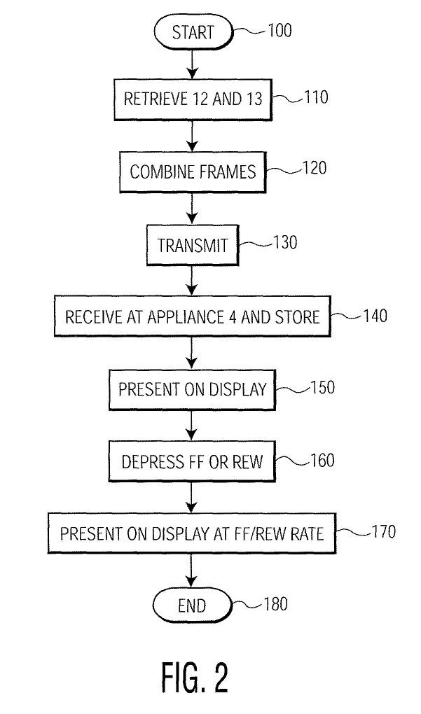

The data storage device 15 may store various application programs, routines and operating programs that are used by the controller 10 for controlling the overall operation of the transmitter station 2, and for performing at least a portion of methods in accordance with this invention, which will be described below in relation to FIGS. 2, 3, and 9. The data storage device 15 preferably also stores various types of video information such as (a) non-advertisement program information 11, which, for the purposes of this description, represents one or more successive video frames having non-advertisement content, wherein the content of a predetermined number of those frames represents at least one non-advertisement program segment, (b) information 12 which, for the purposes of this description, represents one or more successive video frames having advertisement content, wherein the content of a predetermined number of those frames represents at least one advertisement program segment, and (c) slow-motion advertisement information 13, which, for the purposes of this description, also represents one or more successive video frames having advertisement content, wherein the content of a predetermined number of those frames represents at least one advertisement program segment. For example, the content of each frame of the information 11 may include a recorded scene/image and/or text representing a portion of a non-advertisement program to be broadcast, and the content of the individual frames of the information 12 and 13 may include a recorded scene/image and/or text representing a portion of a commercial-advertisement program to be broadcast, although the scenes, images and text of the information 11, 12, and 13 may differ from one another. Each type of information 11, 12, and 13 is retrievable by the controller 10 at predetermined (determined by a clock 10a) or otherwise selected times, for being transmitted from a beginning frame to an ending frame over a predetermined time period towards the external interface 30 via the components 7 and/or 8 and 9.

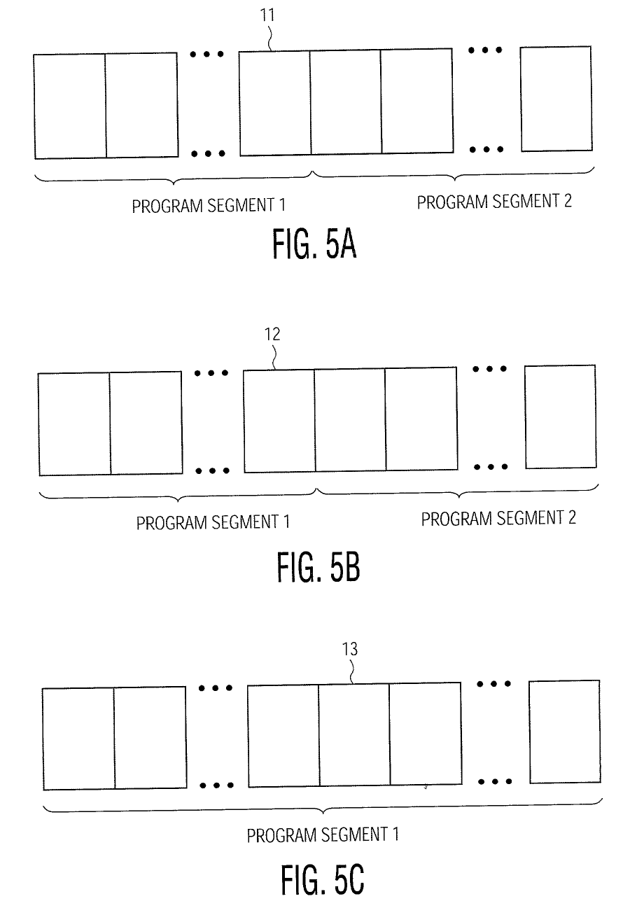

In accordance with an aspect of this invention, individual program segments represented by the slow-motion information 13 preferably are spread out over a greater number of frames of that information 13 than are comparable individual program segments represented by frames of the information 12 and frames of the information 11 (see, e.g., FIGS. 5a-5c), so that the information 13 is configured to correspond to a greater display (playback) frame rate than is the information 11 and 12. For example, in one embodiment of the invention, the individual program segments (and thus the scenes, images and/or text representing those segments) represented by the slow-motion information 13 are spread out over three times as many frames as are comparable program segments represented by frames of each information 11 and 12, so that information 13 is configured to correspond to a predetermined playback frame rate such as, for example, 72 frames per second, that is greater than that (e.g., 24 frames per second) for which the information 11 and 12 is configured. As can be appreciated by one skilled in the art in view of this description, this configuration of the slow-motion information 13 enables changes in scenes represented by the information 13 to appear to occur three times slower than changes in comparable scenes represented by the non-slow motion information 11 and 12, assuming, for the purposes of this description, that such scenes are eventually displayed to a viewer at a same frame rate (although it should be noted that scenes, images, and text represented by the information 11, 12, and 13 may differ from one another, depending on the application of interest). The manner in which the video frames of the information 11-13 are formed, and the manner in which scenes, images, and text are recorded over a selected number of frames to correspond to a particular playback frame rate, may be in accordance with any suitable relevant techniques known in the art, and will not be described herein in detail.

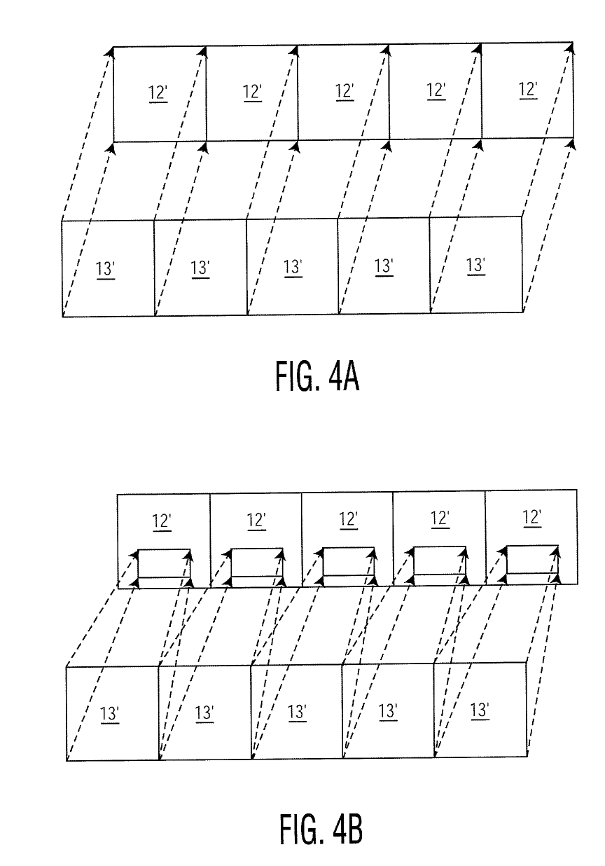

Referring again to FIG. 1, in accordance with one embodiment of this invention, a Picture-In-Picture (PIP) module 5 is included in the controller 10, although in other embodiments that module 5 may instead be a separate component coupled to the controller 10 within the transmitter station 2. The PIP module 5 operates under the control of the controller 10 for constructing either (i) a PIP sub-screen of an image represented by a given video signal, such as a signal representing the information 13 (e.g., by horizontally and vertically compressing the video signal by a predetermined compression ratio) in a manner known in the art, and by combining a signal representing the PIP sub-screen with a signal representing non-sub-screen images (e.g., information 11 or 12) (see, e.g., FIG. 4b), or by (ii) simply combining two given video signals, such as a signal representing the information 13 and a signal representing the information 12 or 11, such that images represented by the information 13 overlay images represented by the information 12 or 11 (see, e.g., FIG. 4a), in a manner known in the art, depending on applicable predetermined operating criteria. The manner in which the PIP module 5 forms a PIP sub-screen signal, and/or combines two given signals may be in accordance with any suitable existing or later developed PIP and combining techniques known in the art. In this regard, reference may be had to U.S. Pat. No. 6,008,860, issued Dec. 28, 1999, by S. W. Patton et al., which is incorporated by reference herein in its entirety as if set forth fully herein, for a description of an example of the manner in which the PIP module 5 may perform such techniques. The controller 10 is programmed to control the size of the PIP sub-screen, when constructed by the module 5, and the position that the PIP sub-screen occupies as an inset of a main video display screen.

It should be noted that, while this invention is described herein in the context of the information 12 and the slow motion information 13 including advertisement content, and the information 11 including non-advertisement content, broadly construed, the invention is not so limited. For example, the information 11, 12, and 13 each may include any other desired types of content in lieu of, or in addition to, advertisement or non-advertisement content, and the scenes, images, and/or text represented by the information 11, 12, and 13 each may be the same or different from one another, depending on applicable operating criteria.

Having described the transmitter station 2, the user information appliance 4 will now be described. In the illustrated example embodiment, the user information appliance 4 comprises at least one communication interface 14, one or more receivers (RXs) coupled to the interface 14 (in the illustrated embodiment, two such receivers 17 and 18 are shown), and a controller 16 coupled to the outputs of the receiver(s). The interface 14 couples the appliance 4 to one or more external communication interfaces, such as the interfaces 30 and 41, and any other external interfaces (not shown) to which the information appliance 4 may be coupled. The interface 14 enables the appliance 4 to receive information from and/or transmit information to, as the case may be, external source and destination devices (e.g., transmitter station 2 and video display apparatus 44) that may be coupled thereto, although for convenience, only the external transmitter station 2, video display apparatus 44, and external interfaces 30 and 41 are shown in FIG. 1. That information may include signaling information in accordance with the applicable external interface standard employed, video information, and other data. Video information outputted by the information appliance 4 to the video display apparatus 44 is displayed on a display screen 44a of the video display apparatus 44, in a known manner.

The receivers 17 and 18 each are tuned to a respective, predetermined channel, and operate in a known manner by selecting a corresponding channel signal from among signals received from the interface 30, and then supplying the selected signal to the controller 16. It should be noted that, although two receivers 17 and 18 are shown in FIG. 1, in other embodiments, more or less than that number of receivers may be employed instead, and/or separate tuners having common supporting amplifiers may be employed instead, depending on the type of appliance 4 employed.

A user interface of the user information appliance 4 includes an output user interface, such as a display 19, and an input user device, typically a key matrix 20, all of which are coupled to the controller 16, although in other embodiments, other suitable types of output and input user interfaces also may be employed. The key matrix 20 includes various user-interface keys that are used for initiating some operation of the user information appliance 4, such as, for example, PLAY, STOP, and PAUSE keys, various search keys such as FAST FORWARD, REWIND, SKIP FORWARD, SKIP REVERSE, etc., and various menu scrolling keys, etc.

The user information appliance 4 preferably also includes various memories, such as a RAM and a ROM, shown collectively as the memory 18. The memory 18 may store temporary data and instructions, various counters and other variables, and preferably also stores various applications, routines, and operating programs 27. For example, in accordance with one embodiment of the information appliance 4, the memory 18 may store a video decoder 35 (e.g., an MPEG decoder) for decoding encoded video data in a conventional manner, and a frame grabber 31 for capturing single frames from a video signal in a known manner, although other types of operating systems and application software may be employed instead, and/or one or more of the applications, such as applications 31 and 35 may be embodied as separate hardware components within the appliance 4. At least some of the routines stored in the memory 18 implement at least a portion of methods in accordance with this invention, to be described below in relation to FIGS. 2, 3, and 9.

Referring now to the controller 16, it is understood that the controller 16 also includes circuitry required for implementing necessary video and logic functions of the information appliance 4, such as a digital signal microprocessor device, a microprocessor device, various analog to digital converters 11a, digital to analog converters 11b, and other support circuits. The control and signal processing functions of the information appliance 4 are allocated between these devices according to their respective capabilities.

A recording/playback portion 40 coupled to the controller 16 employs a mechanism which performs various mechanical functions for the information appliance 4, such as loading and unloading of a recording medium 42, such as a magnetic tape or a video disc, recording of video signals on that recording medium 42, reproduction of the video signals recorded on the recording medium 42, fast forwarding and rewinding operations, forward or reverse skipping operations, and the like. For example, the recording/playback portion 40 may include a transport system, in the case of a VCR, or a disc drawer, mechanical tray, sled mechanism, and optical component assembly, in the case of digital video recorders, although in other embodiments, other suitable existing or later developed types of recording/playback mechanisms may be employed instead for the portion 40. Reference may be had to a publication by Robert Goodman, entitled “How Electronic Things Work . . . And What To Do When They Don't”, McGraw-Hill, 1999, pages 83-102 and 157-189, for a description of components which may be included in the recording/playback portion 40 in the cases of digital video recorders and VCRs, respectively.

In accordance with one embodiment of the invention, the information appliance 4 also comprises a Picture-In-Picture (PIP) module 46 which operates under the control of the controller 16 for either (i) constructing a PIP sub-screen of an image represented by a given video signal, such as a signal representing the information 13 (e.g., by horizontally and vertically compressing the video signal by a predetermined compression ratio) in a manner known in the art, and by combining a signal representing the PIP sub-screen with a signal representing non-sub-screen images (information 11 or 12) (see, e.g., FIG. 4b), or by (ii) simply combining two given video signals, such as a signal representing the information 13 and a signal representing the information 12 or 11, such that images represented by the information 13 overlay images represented by the information 12 or 11 (see, e.g., FIG. 4a), in a manner known in the art, depending on applicable performance criteria. Like the controller 10 of the transmitter station 2, the controller 16 is programmed to control the size of the PIP sub-screen, when constructed by the module 46, and the position that the PIP sub-screen occupies as an inset of a main video display screen. The manner in which the PIP module 46 forms a PIP sub-screen signal, and/or combines two given signals, may be in accordance with any suitable existing or later developed PIP and combining techniques known in the art, such as, for example, those described in U.S. Pat. No. 6,008,860, which, as mentioned above, is incorporated by reference herein.

Having described the various components of the overall system 1 shown in FIG. 1, an aspect of this invention will now be described, with reference to the flow diagram of FIG. 2 in conjunction with FIGS. 1 and 6. In accordance with this aspect of the invention, slow-motion video information including predetermined content, such as one or more commercial advertisement program segments, can be inserted into broadcast video information which is to be eventually presented to a viewer.

In step 100 of FIG. 2, the method is started, and it is assumed that, while or after non-advertisement program information 11 from the data storage device 15 is being broadcast from the transmitter station 2 by way of interface 30, the controller 10 recognizes, based on, for example, the clock 10a and program schedule information stored in device 15, that a predetermined time has been reached at which advertisement program segments are scheduled to begin being broadcast from the transmitter station 2 over a predetermined time period. As a result, the controller 10 begins to retrieve (a) the information 12 (beginning with a starting frame thereof) (in FIG. 6, block 10′ represents a step of the controller selecting either the information 11 or the information 12) and (b) the slow-motion information 13 (beginning with a starting frame thereof) from the device 15 (step 110). As the information 12 and 13 is retrieved, it is provided to the PIP module 5 and combined thereby to produce a composite signal (step 120 of FIG. 2; block 10″ in FIG. 6). For example, according to one embodiment of the invention, step 120 is performed so that each individual frame 13′ of the information 13 is caused to be inserted as a sub-frame (e.g., sub-screen) within a predetermined portion of a corresponding frame 12′ of the information 12 (i.e., to form a “picture-in-picture”) (FIG. 4b), or, according to another embodiment of the invention, so that each individual frame 13′ of information 13 completely overlays the corresponding frame 12′ of the information 12 (FIG. 4a). In the former case, the frames 13′ may be inserted into a predetermined portion of the corresponding frames 12′, such as a lower portion of the frames 12′, to avoid covering images appearing in other portions of the frames 12′ (FIG. 4b), although the insertion may be made into other portions of the frames 12′ instead/as well, as determined by the controller 10 in accordance with predetermined operating criteria. After individual frames of the information 12 and 13 are combined in step 120, the resulting combined frames are forwarded in a composite signal to the transmitter 8, which then responds to receiving the signal by transmitting it over a predetermined channel through the interface 30 to the user information appliance 4 (step 130).

For the purposes of this description, it is assumed that, while the composite signal is being transmitted in step 120, the information appliance 4 is operating in a first, recording mode in which it records information received from the interface 30 on the recording medium 42 (e.g., about 24 frames per second). Thus, in the present example embodiment, as the composite signal transmitted by the transmitter station 2 is received in the appliance 4 via, for example, the components 14, 17, and 16, the combined information represented by the signal is stored in the recording medium 42 by the controller 16 (step 140). Then, at some time later, and assuming that the first, recording mode has been terminated (e.g., by a user selecting the STOP key) after the information broadcast by the transmitter station 2 was recorded, it is assumed that the user of the information appliance 4 operates the key matrix 20 to specify that the appliance 4 operate in a second, playback mode, which causes the recorded information (e.g., the combined information 12 and 13) to be displayed by the video display apparatus 44 (step 150). For example, the user may cause the information appliance 4 to operate in the second, playback mode by depressing the “PLAY” key of the key matrix 20, in which case the controller 16 responds by activating the recording/playback portion 40 to cause it to read/retrieve the recorded information from the medium 42 at a predetermined read/retrieval rate corresponding to the second, playback mode, and then cause the relevant information to be displayed on the display screen 44a in a known manner, and at a first, corresponding predetermined frame display rate (e.g., 24 frames per second). As can be appreciated in view of this description, in this example, when the information is displayed by the display apparatus 44, subject matter (e.g., scenes, images, and/or text) represented by the frames 13′ (FIGS. 4a and 4b) appears to change more slowly (i.e., in “slow-motion”) to a viewer relative to subject matter represented by frames 12′, assuming, for the purposes of this description, that comparable subject matter is represented by those frames, owing to the above-described “slow-motion” configuration of the information 13, even though the frames 12′ and 13′ are presented at the same frame rate.

If the user of the information appliance 4 then operates the key matrix 20 by depressing a search key of the matrix 20, such as, for example, the FAST FORWARD or REWIND key (step 160), while the appliance 4 is operating in the second playback mode for playing back the information recorded in earlier step 140, the controller 16 responds by causing the appliance 4 to operate in a third, search mode. During that latter mode, the recording/playback portion 40 reads/retrieves the recorded information from the medium 42 (either forward or in reverse) at a greater predetermined read/retrieval rate corresponding to the third, search mode, and then causes the information, as it is being read/retrieved, to be displayed on the display screen 44a in a known manner, and at a second corresponding predetermined frame rate (e.g., 72 frames per second) which is greater than the first frame rate used during the second, playback mode (step 170). As can be appreciated by one skilled in the art in view of this description, the second predetermined frame rate corresponds to the increased speeds at which the relevant mechanical components (e.g., capstan, reels, or sled mechanism) of the portion 40 are driven by the controller 16 during the third, search mode, relative to those employed in the second, playback mode. As a result of the performances of steps 160 and 170, the displayed subject matter represented by the frames 13′ of the displayed information still appears to change more slowly to a viewer relative to subject matter represented by frames 12′, but at a rate which is substantially the same as that of subject matter of the frames 12′ when presented at the first predetermined frame rate during step 150, assuming that, for the purposes of this description, comparable subject matter is included in the frames 12′ and 13′, owing to the configuration of the slow-motion information 13 (see, e.g., FIG. 5c). The subject matter represented by the frames 12′, on the other hand, appears to change at a faster rate (e.g., three times as fast) relative to the rate at which the subject matter of the frames 12′ changed when presented at the first predetermined frame rate in earlier step 150. As a result, even though the user initiated the third, search mode in step 160, which generally causes video information to be displayed at a frame rate which often is too fast for enabling a played back program segment to be displayed in its intended form to a viewer, the frames 13′ are displayed in step 170 at their intended, second predetermined frame rate (e.g., 72 frames per second). As a result, the one or more advertisement program segments represented by those frames 13′ are presented to the user in their intended form.

Thereafter, control passes to step 180 where, for the purposes of this description, it is assumed that the user selects another function (e.g., “PAUSE”, “STOP”, “PLAY”, etc.) of the information appliance 4, which then responds in an appropriate known manner, and then the method is terminated.

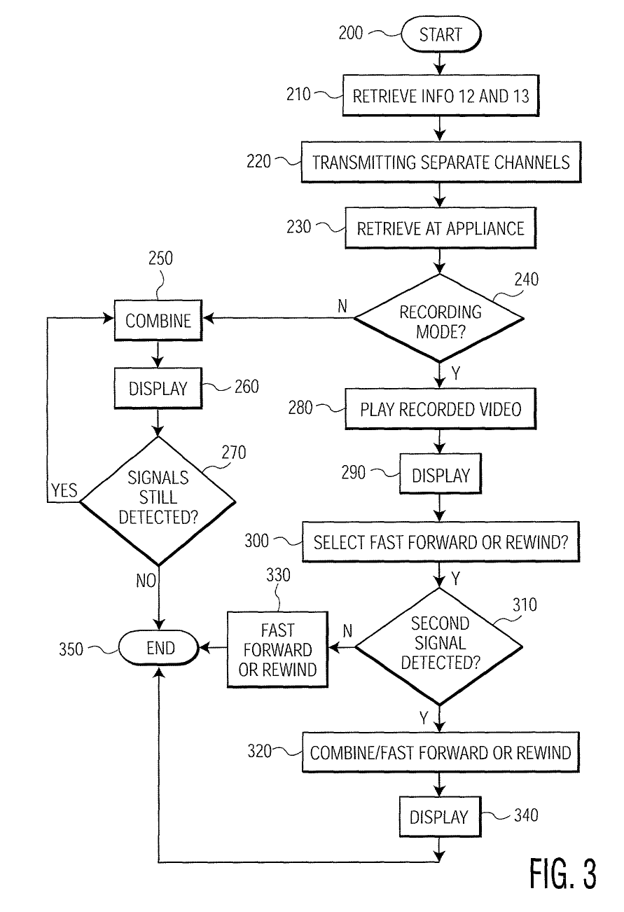

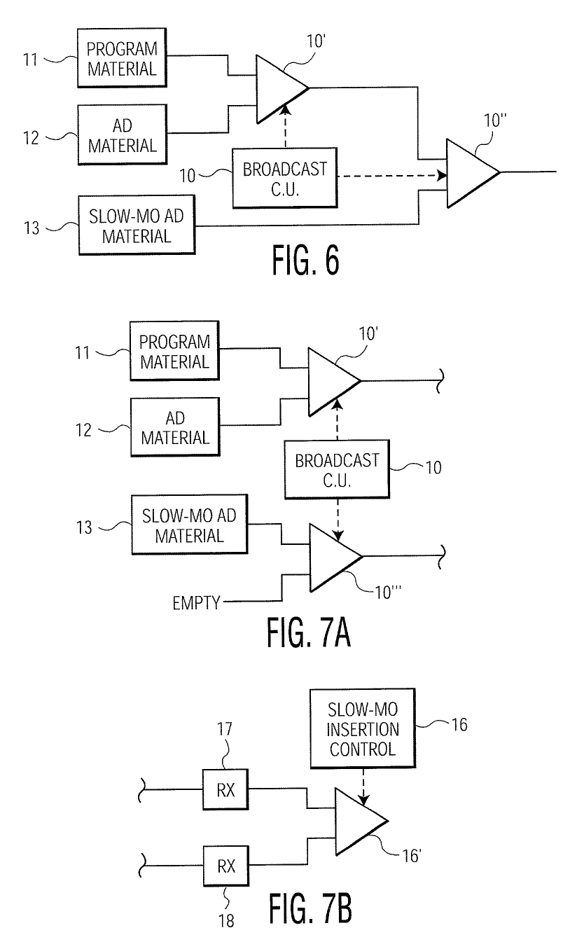

A method in accordance with another embodiment of this invention will now be described, with reference to the flow diagram shown in FIG. 3 in conjunction with FIGS. 1, 7a, and 7b. In accordance with this embodiment of the invention, information 12 and 13 originally broadcast by the transmitter station 2 is combined within the information appliance 4, as it is being received by the appliance 4, for being presented on the display apparatus 44. The combining of the information 12 and 13 may be performed while the information 12 and 13 is being received in real-time, or after the information 12 and/or 13 already has been received and stored in the apparatus 4, as will be described in detail below.

In step 200 of FIG. 3, the method in accordance with this embodiment of the invention is started, and it is assumed that, while or after program information 11 from the data storage device 15 is broadcast from the transmitter station 2 by way of interface 30, the controller 10 recognizes, based on, for example, the clock 10a and program schedule information stored in device 15, that a predetermined time has been reached at which one or more commercial advertisement segments are scheduled to begin being broadcast from the transmitter station 2 over a predetermined time period, in a similar manner as described above. As a result, the controller 10 begins to retrieve (a) the information 12 (beginning with a starting frame thereof) (in FIG. 7a, block 10′ represents the controller 10 selecting either the information 11 or the information 12) and (b) the slow-motion information 13 (beginning with a starting frame thereof) from the device 15 (step 210 of FIG. 3; block 10′″ of FIG. 7a). As the information 12 and 13 is retrieved, it is provided to the transmitters 8 and 7, respectively. The transmitter 8 then, in turn, transmits the information 12, as it is received thereby, in a first video signal over an associated first communication channel through the interface 30 towards information appliance 4. Similarly, transmitter 7 transmits the information 13, as it is received thereby, in a second video signal over a second associated communication channel through the interface 30 towards the information appliance 4 (step 220).

In step 230, the first and second video signals begin to be received by the receivers 17 and 18, respectively, and the information 12 and 13 represented by those respective signals is provided to the controller 16. According to one embodiment of the invention, in cases in which the appliance 4 is operating in a non-recording, pass-through mode, in which it forwards received video signals to the apparatus 44 for being displayed in substantially real time (“N” in step 240), without recording those signals, control passes to step 250 where the controller 16 responds to receiving the information 12 and 13 from the respective receivers 17 and 18 by providing that information 12 and 13 to the PIP module 46, which, in turn, responds by combining the information in the same manner as described above in relation to step 120 of FIG. 2 (step 250 of FIG. 3; block 16′ of FIG. 7b).

Information resulting from the performance of step 250 is then provided, as it is being generated, back to controller 16, which then forwards the resulting information to the video display apparatus 44 via the interface 41. Apparatus 44 then responds to receiving that information by presenting it on the display screen 44a, as it is being received (step 260). As can be appreciated in view of this description, when the information is displayed by the display apparatus 44, subject matter (e.g., advertisement segment) of the frames 13′ (FIGS. 4a and 4b) appears to change more slowly (i.e., in “slow-motion”) to a viewer relative to subject matter included in the frames 12′, assuming, for the purposes of this description only, that comparable subject matter is represented by those frames 12′ and 13′, owing to the above-described “slow-motion” configuration of the information 13.

Thereafter, steps 250 and 260 may continue to be performed for as long as the first and second video signals continue to be received within the appliance 4 (“Y” in step 270), or until the appliance 4 is powered down or otherwise disabled. When the controller 16 no longer detects one or both of those signals (“N” in step 270), or the appliance 4 is powered down or otherwise disabled, control passes to step 350 where no further combining operation is performed and the method is terminated, although, as can be appreciated by one skilled in the art in view of this description, if one of the first and second video signals is still being received, the information represented by that signal may continue to be presented on the display 44.

In accordance with another embodiment of the invention, no combining operation 250 is performed in response to a determination in step 240 that the appliance 4 is not operating in a recording mode (“N” in step 240). For example, in that embodiment, a determination of “No” in step 240 results in the appliance 4 simply causing the received information 12 to be presented by the display apparatus 44, in a known manner, and the controller 16 either storing or discarding the received information 13.

Referring again to the embodiment illustrated in FIG. 3, and in particular to step 240 of that figure, another aspect of this invention will now be described. In accordance with this aspect of the invention, the appliance 4 causes “slow-motion” information 13 being received in real-time by the apparatus 4, or which has been pre-recorded within the apparatus 4, to be presented by the display apparatus 44 in response to a user selecting a search operation during a playback operating mode of the apparatus 4.

For the purposes of describing this aspect of the invention, it is assumed that the information appliance 4 is operating in the first, recording mode while first and second video signals are being received by the information appliance 4 in the above-described manner (“Y” in step 240). For example, the information appliance 4 may be caused to operate in that mode by the user selecting one or more predetermined keys (e.g., a “RECORD” key) of the key matrix 20, or in response to a predetermined time already pre-programmed in the controller 16 being reached. In either case, the controller 16 responds by, according to one embodiment of the invention, causing the information 12 represented by video signals received through the receiver 17 to be recorded on the recording medium 42 (e.g., at 24 frames per second), in a known manner. The recording operation in step 240 is performed for as long as, for example, the one or more predetermined keys are depressed, or for the duration of a predetermined time period pre-programmed in the controller 16.

At some time after the recording operation in step 240 is completed, it is assumed the user desires to view the recorded information 12. As such, the user again operates the key matrix 20, but this time to specify that the appliance 4 operate in the second, playback operating mode (step 280). For example, the second, playback operating mode may be invoked by the user depressing the “PLAY” key of the key matrix 20. The controller 16 then responds by activating the recording/playback portion 40 to cause the portion 40 to begin reading/retrieving the recorded information 12 from the medium 42 at a predetermined read/retrieval rate corresponding to the second, playback mode, and to cause that information to be displayed on the display screen 44a in a known manner, and at the first, corresponding predetermined frame rate (e.g., 24 frames per second) (step 290).

At some time later, but while the appliance 4 is still operating in the second, playback mode, it is assumed that the user desires to perform a forward or reverse search of the information 12 recorded in step 240, and thus operates the key matrix 20 by depressing the search key(s) of the matrix 20, such as, for example, the FAST FORWARD or REWIND key (step 300). The controller 16 then responds by determining whether or not information 13 (originally broadcast from station 2) is being received therein from the receiver 18 (step 310), although in other embodiments, that step may be performed instead by the controller 16 determining whether both information 13 from the receiver 18 and information 12 from the receiver 17 are being received. In either case, if the performance of step 310 results in a determination of “No” (“N” in step 310), then control passes to step 330 where the controller 16 controls the recording/playback portion 40 to cause it to operate in the third, search mode in which the portion 40 starts to read/retrieve the recorded information 12 from the medium 42 (either forward or in reverse) at a greater predetermined read/retrieval rate corresponding to the third, search mode. Since the searching operation was invoked while appliance 4 was operating in the second, playback mode, the read/retrieved information 12 is displayed on the display screen 44a, but at a second corresponding predetermined frame rate (e.g., 72 frames per second) which is greater than the first predetermined frame rate used during the second, playback mode when no search was being performed (step 330). In this manner, the appliance 4 performs a conventional search operation to the information 12 recorded in earlier step 240. The search and display operations of step 330 are performed until, for example, the search key(s) is not longer depressed or the search has been otherwise completed, and control then passes to step 350 where, for the purposes of this description, the method is terminated.

A case in which the performance of step 310 results in a determination of “Yes” will now be described. If in step 310 the controller 16 determines that either the information 13, or both the information 12 and 13, depending on which embodiment is being employed, is being received from the receiver 18, or the receivers 17 and 18, respectively (“Y” in step 310), then control passes to step 320 where the controller 16 causes the appliance 4 to operate in the third, search mode by controlling the recording/playback portion 40 to cause it to start to read/retrieve the information 12 (either in forward or reverse mode) recorded on the medium 42 (in earlier step 240) at the greater predetermined read/retrieval rate corresponding to the third, search mode, in the same manner as described above. Also in step 320, the controller 16 provides the information 12, as it is being read/retrieved, and also provides the information 13, as that information 13 is being received in real time from the receiver 18, to the PIP module 46, which, in turn, then responds by combining the information 12 and 13, as it is being received thereby, in the same manner as described above in relation to step 120 of FIG. 2 (step 320 of FIG. 3; block 16′ of FIG. 7b).

Information resulting from the combining operation performed in step 320 is provided back to the controller 16 by the module 46, and then to the video display apparatus 44 for being displayed thereby. Owing to the appliance 4 being controlled to operate at the third, search mode in step 320, while the appliance 4 already was operating in the second, playback mode, the information is presented on the display screen 44a, but at the second corresponding predetermined frame rate (e.g., 72 frames per second) (step 340). In this case, displayed subject matter represented by the frames 13′ still appears to change more slowly to a viewer relative to subject of the frames 12′, but preferably at a rate which is substantially the same as that of subject matter of the frames 12′ when displayed during the second, playback mode at the first predetermined frame rate in step 290. The subject matter represented by the frames 12′, on the other hand, appears to change at a faster rate (e.g., three times as fast) than the rate experienced when the frames 12′ were presented at the first predetermined frame rate in earlier step 290. As a result, even though the user initiated the third, search mode in step 300, which generally causes video information to be displayed at a frame rate which is too fast for enabling a played back program segment to be displayed in its intended form, the frames 13′ are displayed in step 340 at the intended, second predetermined frame rate (e.g., 72 frames per second). As a result, the one or more advertisement program segments represented by those frames 13′ are presented to the user in their intended form.

The apparatus 44 then continues to display the information in this manner as it is received from the apparatus 4, until, for example, the search or playback mode is discontinued or information 13 (or 13 and 12) is no longer detected as described above in step 310, where, in either case, and for the purposes of this description, control passes to step 350 and the method terminates.

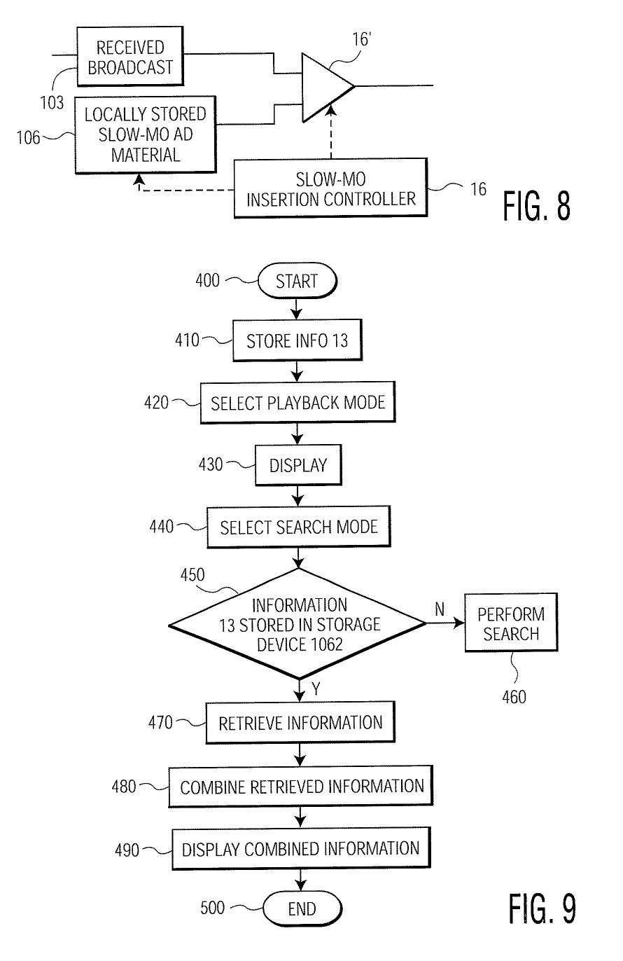

A further aspect of this invention will now be described. In accordance with this aspect of the invention, and referring now to FIGS. 8 and 9 in conjunction with FIG. 1, the “slow-motion” information 13 is pre-stored in a storage device 106 that is either included within the appliance 4 or within an external storage medium (not shown) associated with the apparatus 4, before being combined with other information (e.g., information 12) and being presented on the display 44. For example, in one embodiment of the invention, as the information 13 is being received within the appliance 4 from the interface 30 (after being broadcast in a video signal from the station 2 in step 400) and provided through the receiver 18 to the controller 16, the information 13 is stored by the controller 16 in a storage device 106 (step 410), which may be the recording medium 42, or, in other embodiments, the memory 18, or an external storage medium (not shown) coupled to the appliance 4. That information 13 may be stored as it is being received in real time while the appliance 4 is operating in the first, recording mode. In other embodiments, the information 13 may be originally transmitted within a video signal from the transmitter station 2 at a selected or otherwise predetermined date and time (e.g., 2 A.M.), either separately from, or simultaneous with, a transmission of a video signal 103 including the information 11 and/or 12, wherein, in any case, after being received by the apparatus 4, the information 13 is stored by the controller 16 in the storage device 106. Alternatively, the information 13 may be provided in some other manner to the appliance 4 for storage in the device 106, rather than being received in a video signal broadcast by the transmitter station 2. For example, the information may be downloaded from some other predetermined source, or be otherwise stored in the storage device 106.

At some time after the information has been stored in the storage device 106 in step 410, it is assumed that the user operates the appliance 4 to select the second, playback mode to cause video information pre-recorded in the recording medium 42, such as the information 12 (which may have been pre-recorded during an earlier broadcast of the information 12 from the transmitter station 2) to be retrieved and displayed on the display 44 in the above-described manner (step 430). If the user then subsequently selects the third, search mode by selecting, for example, the FAST FORWARD or REWIND key, while the second, recording mode is still being performed (step 440), the controller 16 responds to the user selection of the third, search mode by determining whether or not information 13 is stored in the storage device 106 (step 450). If the controller 16 determines that no information 13 is stored in the device 106 (“N” in step 450), then the controller 16 initiates the third, search mode by controlling the recording/playback portion 40 to cause a forward or reverse search (depending on which key was selected in step 440) of the video information stored in the medium 42 to be performed (step 460), in a conventional manner, and as described above in connection with step 330 of FIG. 3. The search then continues until, for example, it is discontinued by the user, and then control passes to step 500 where the method terminates.

If, on the other hand, the controller 16 determines in step 450 that information 13 is stored in the storage device 106 (“Y” in step 450), then the controller 16 controls the recording/playback portion 40 to cause it to operate in the third, search mode in which the portion 40 starts to read/retrieve the prerecorded video information, such as the information 12, from the medium 42 (in forward or reverse mode), at the predetermined read/retrieval rate corresponding to the third, search mode. The controller 16 then provides the information 12, as it is being read/retrieved, and also provides the information 13, which the controller 16 retrieves from the storage device 106 (step 470), to the PIP module 46, which, in turn, then responds by combining the information 12 and 13 as it is being received by the module 46, in the same manner as described above (step 480). For example, according to one embodiment of the invention, step 480 is performed so that each individual frame 13′ of the information 13 is caused to be inserted as a sub-frame (e.g., sub-screen) within a predetermined portion of a corresponding frame 12′ of the information 12 (i.e., to form a “picture-in-picture”) (FIG. 4b), as described above, or, according to another embodiment of the invention, so that each individual frame 13′ of information 13 completely overlays the corresponding frame 12′ of the information 12 (FIG. 4a).

After individual frames of the information 12 and 13 are combined in step 480, the resulting combined frames are forwarded by the module 46 back to the controller 16, which then provides the combined frames, as they are being received, to the video display appliance 40 for being displayed thereby (step 490). Owing to the appliance 4 being controlled to operate in the third, search mode while the appliance 4 was operating in the second, playback mode, the combined frames are presented on the display screen 44a at the second predetermined frame rate (e.g., 72 frames per second) corresponding to the third, search mode. As described above in connection with FIG. 3, in the present embodiment, displayed subject matter represented by the frames 13′ appears to change more slowly to a viewer relative to subject of the frames 12′, but preferably at a rate which is substantially the same as that of subject matter of the frames 12′ when displayed at the first predetermined frame rate. The subject matter represented by the frames 12′, on the other hand, appears to change at a faster rate (e.g., three times as fast) than that employed when the frames 12′ were presented at the first predetermined frame rate. As a result, even though the user initiated the third, search mode in step 440, which generally causes video information to be displayed at a frame rate which is too fast for enabling a played back program segment to be displayed in its intended form, the advertisement segment(s) represented by the frames 13′ are displayed in their intended form to the viewer in step 490.

The appliance 4 then continues to cause the information to be displayed in this manner until, for example, the search or playback mode is discontinued, the information 13 is no longer detected in the storage device 106, or the appliance 4 is powered-off or otherwise disabled, wherein, in any of those cases, and for the purposes of this description, the method terminates (step 500).

Although the embodiment discussed above in connection with FIGS. 8 and 9 is described in the context of the controller 16 determining whether information 13 is stored in the storage device 106 in step 450, in response to the third, search mode being initiated in step 440, in accordance with another embodiment of the invention, the controller16 instead performs step 450 by determining whether information that is being read/retrieved from medium 42 as a result of the second, playback mode being initiated in earlier step 420, includes predetermined content, such as advertisement content (e.g., the information 12), although in other embodiments that determination may be performed to determine whether the information being read/retrieved includes non-advertisement content (such as the information 11) or some other predetermined type of content. The determining step 450 according to this embodiment of the invention, and the various detection steps described above (e.g., steps 270 and 310), may be performed using any suitable type of existing or later developed technique for detecting predetermined content in media information streams. For a description of examples of some known techniques which may be employed, reference may be had to (1) U.S. Pat. No. 6,100,941, issued on Aug. 8, 2000, entitled “Apparatus and Method for Locating a Commercial Disposed Within a Video Data Stream,” by Nevenka Dimitrova, Thomas McGee, Herman Elenbaas, Eugene Leyvi, Carolyn Ramsey, and David Berkowitz (hereinafter “U.S. Pat. No. 6,100,941”), and (2) U.S. patent application Ser. No. 09/854,511, filed May 14, 2001, entitled “Video Content Detection Method And System Leveraging Data-Compression Constructs”, each of which is incorporated by reference herein in its entirety, as if fully set forth herein, although, broadly construed, the invention is not limited to being performed using only those techniques (those techniques or other suitable content detection techniques also may be employed in steps 270 and 310 of FIG. 3 and/or in step 450 in the embodiment of FIG. 9 described above).

In accordance with the present embodiment, in which step 450 is performed to determine whether information being read/retrieved from medium 42 includes predetermined content, wherein, for the purposes of this description, it is assumed that the predetermined content includes advertisement content and the read/retrieved information includes pre-recorded information 12, if the predetermined content is detected in step 450, then controller 16 controls the recording/playback portion 40 in the above-described manner to cause it to invoke the third, search mode. As described above, in that mode the portion 40 starts to read/retrieve the pre-recorded information 12 from the medium 42 (in forward or reverse mode) at a predetermined read/retrieval rate corresponding to the third, search mode. The controller 16 then provides the information 12, as it is being read/retrieved, and the information 13, which is retrieved from the storage device 106 (step 470), to the PIP module 46 which combines the information 12 and 13 as it is being received thereby, in step 480, in the same manner as described above, and the resulting combined information is then caused to be displayed on the display 44 in step 490. Owing to the appliance 4 being controlled to operate in the third, search mode in step 440 while the appliance 4 was operating in the second, playback mode, in this embodiment the combined information is presented on the display screen 44a at the second predetermined frame rate (e.g., 72 frames per second) corresponding to the third, search mode, and thus the program segments represented by the frames 13′ included in the combined information are presented to a viewer in their intended form.

The appliance 4 then continues to cause the combined information to be displayed in this manner until, for example, the search or playback mode is discontinued, advertisement content (e.g., information 12) is no longer detected from the storage medium 42, or the appliance 4 is powered-off or otherwise disabled, where, in any of those cases, and for the purposes of this description, the method terminates (step 500).

As has been described in the foregoing description, the present invention provides a technique, program, and apparatus which enable one or more advertisements recorded on a recording medium to be presented in their intended formed to a viewer, even though a high speed forward or reverse search through the recording medium may be being performed. As can be appreciated in view of this description, this result is particularly advantageous in cases in which the viewer is paying greater attention to the display screen.

Although the invention is described above in the context of information being displayed in steps 170, 340, and 490 in response to a user initiating a search mode of the appliance 4 by selecting a search key while the apparatus 3 is operating in a playback mode, broadly construed, the invention is not so limited, and it also is within the scope of this invention to perform such displaying in response to a user selecting one or more other predetermined keys of the key matrix 20, or in response to the occurrence of a predetermined time or some other predetermined event, or, in other embodiments, the displaying may be performed in response to the search mode being initiated while the appliance 4 is not already operating in the playback mode. That is, it also is within the scope of this invention to display the combined frames 12′ and 13′ (see, e.g., FIGS. 4a and 4b) in a manner which enables the advertisement segments represented by the frames 13′ to be presented in their intended form, in response to other predetermined events, besides in response to the third, search mode being initiated during the second, playback mode.

It also should be noted that, although the invention is described above in the context of video information being displayed at either a first predetermined frame display rate or a second predetermined frame display rate, depending on whether the second, playback mode or the third, search mode is being performed, and in the context of the video information 11-13 being configured (e.g., with a particular number of frames per program segment) to correspond to one of those rates, broadly construed, the invention is not so limited. Indeed, it also is within the scope of this invention to employ other suitable frame display rates and corresponding configurations of the video information, besides those described above, depending on applicable operating criteria. In other embodiments, the frame display rates may depend on (e.g., be proportional to) the amount of force applied to a relevant playback or search key of the key matrix 20, and the information 11-13 may be configured to account for this feature.

It also should be noted that, although the invention is described above in the context of the information 12 and 13 representing advertisement program segments, and the information 11 representing non-advertisement program segments, the invention is not so limited, and each type of information 11-13 may represent other types of video information than those described above. It also is within the scope of this invention to combine the information 13 with non-advertisement program segments, such as those represented by the information 11, or to combine plural information which each represents both advertisement and non-advertisement programs segments, or to combine only information representing non-advertisement program segments. It should therefore be clear that the invention is not limited for use with any particular type of video information or program content, and that the invention may be used in conjunction with any suitable type of video information and program content of interest.

It should further be noted that, although the invention is described above in the context of the first and second video information being combined in the module 5 or 46 of the above-described embodiments, in accordance with other embodiments of this invention, the first and second information need not be so combined in those components, and instead may be forwarded from/through the relevant source and intermediate components described above to the display apparatus 44, after the second video information is either compressed by the component 5 or 46 or not (and after the search mode or some other predetermined event is invoked), and then the first and second video information is displayed together by the display apparatus 44 at one of the above-described frame display rates, depending on the operating mode of the playback/retrieval portion 40. In those embodiments of this invention, frames of the second video information may be displayed as a sub-screen within corresponding frames of the first information, or as a same sized screen as the first video information, depending on applicable operating criteria. In a variation of these embodiments, the second information may include stationary text or image(s), rather than video, and that second information and the first video information, each of which may originate in one of the devices 2 and 4 as described above, may be presented simultaneously on the display apparatus 44 in response to a user invoking the search operation or some other predetermined event, in the above-described manner. As for the other embodiments, the second information may be displayed as a sub-screen within a screen of the first video information, or as a same size screen as the first video information, depending on applicable operating criteria. The manner in which the above-described methods would need to be modified to operate in accordance with these embodiments of the invention would be readily appreciated by one skilled in the art in view of this description.

Although the foregoing description has been described in the context of the methods of the invention being implemented using software instructions, in other embodiments hardware circuitry may be used in place of such instructions for implementing the methods of the invention. The particular types of circuitry employed would be readily appreciated by those of ordinary skill in the art, in view of this description.

While the invention has been particularly shown and described with respect to preferred embodiments thereof, it will be understood by those skilled in the art that changes in form and details may be made therein without departing from the scope and spirit of the invention.

What is claimed is:

1. A method for displaying video information, comprising the steps of:
combining first and second video information to form combined video information, the first and second video information representing first and second video frames, respectively, wherein at least one first program segment is represented by a first number of the first video frames, at least one second program segment is represented by a second number of the second video frames, and the first and second numbers are predetermined to correspond to first and second predetermined frame display rates, respectively; and
displaying at least a portion of at least one of the first and second program segments represented by the combined information, at one of the first and second predetermined frame display rates.

2. A method as set forth in claim 1, wherein at least one of the first and second program segments relates to an advertisement.

3. A method as set forth in claim 1, wherein the second predetermined frame display rate is greater than the first predetermined frame display rate.

4. A method as set forth in claim 1, wherein the combining step includes inserting individual ones of the second video frames into at least a portion of corresponding individual ones of the first video frames.

5. A method as set forth in claim 4, wherein the inserting step inserts each individual second video frame as a Picture-In-Picture (PIP) sub-frame into a corresponding first video frame, and the displaying step displays each individual second video frame as a PIP sub-screen in the corresponding first video frame.

6. A method as set forth in claim 1, further comprising transmitting the combined information to a destination before the displaying step is performed, and wherein the displaying step is performed at the destination.

7. A method as set forth in claim 1, wherein the destination includes a user information appliance, and the combining step is performed in response to a user-generated input signal inputted into the user information appliance.

8. A method for operating at least one user information terminal provided with video information, comprising the steps of:
generating an input signal in the user information appliance in response to a user-interface of the user information appliance being operated;
in response to the input signal generated in the generating step, combining first and second video information to form combined video information, the first and second video information representing first and second video frames, respectively, wherein at least one first program segment is represented by a first number of the first video frames, at least one second program segment is represented by a second number of the second video frames, and the first and second numbers are predetermined to correspond to first and second predetermined frame display rates, respectively; and
displaying at least a portion of at least one of the first and second program segments represented by the combined information, at one of the first and second predetermined frame display rates which corresponds to the input signal generated in the generating step.

9. A method as set forth in claim 8, wherein the input signal generated in the generating step specifies that the user information appliance operate in a search mode for searching through at least one of the first and second video information, the search mode corresponds to the second predetermined frame display rate, and the displaying step performs the displaying at the second predetermined frame display rate corresponding to the search mode.

10. An apparatus for manipulating video information, comprising:
electronic interface means, for being coupled to display means; and
means, coupled to said electronic interface means, for combining provided first and second video information to form combined video information, and for outputting the combined video information through said electronic interface means to cause said display means to display at least a portion of the combined information at one of a first predetermined frame display rate and a second predetermined frame display rate, wherein the first and second video information represent first and second video frames, respectively, at least one first program segment is represented by a first number of the first video frames, at least one second program segment is represented by a second number of the second video frames, and the first and second numbers are predetermined to correspond to the first and second predetermined frame display rates, respectively.

11. A transmitter station, comprising:
a storage area for storing at least first and second video information, the first and second video information representing first and second video frames, respectively, wherein at least one first program segment is represented by a first number of the first video frames, at least one second program segment is represented by a second number of the second video frames, and the first and second numbers are predetermined to correspond to first and second predetermined frame display rates, respectively;
a combiner, arranged to combine the first and second video information stored in the storage area to form combined video information representing a combination of the first and second video frames; and
at least one transmitter, arranged to transmit the combined video information formed by the combiner, from the transmitter station.

12. A transmitter station as set forth in claim 11, wherein at least one of the first and second program segments relates to an advertisement.

13. A transmitter station as set forth in claim 11, wherein the second predetermined frame display rate is greater than the first predetermined frame display rate.

14. A transmitter station as set forth in claim 11, wherein the combiner combines the first and second video information by inserting individual ones of the second video frames into at least a portion of corresponding individual ones of the first video frames.

15. A transmitter station as set forth in claim 14, wherein the combiner performs the inserting by inserting each individual second video frame as a Picture-In-Picture (PIP) sub-frame into a corresponding first video frame.

16. A system for communicating video information, comprising:
a transmitter station, comprising:
a storage area for storing at least first and second video information, the first and second video information representing first and second video frames, respectively, wherein at least one first program segment is represented by a first number of the first video frames, at least one second program segment is represented by a second number of the second video frames, and the first and second numbers are predetermined to correspond to first and second predetermined frame display rates, respectively,
a combiner, arranged to combine the first and second video information stored in the storage area to form combined video information representing a combination of the first and second video frames, and
at least one transmitter, arranged to transmit the combined video information formed by the combiner, from the transmitter station; and
at least one receiver station, comprising:
at least one electronic interface, arranged to receive the combined video information transmitted by the transmitter station, and
a display, arranged to display at least a portion of the combined video information at one of the first predetermined frame display rate and the second predetermined frame display rate.

17. A system as set forth in claim 16, wherein the receiver station further comprises:
an input user-interface, operable by a user for generating either a first user-generated signal or a second user-generated signal;
a recording/retrieving portion, operable in a recording mode for recording information on a recording medium or a retrieving mode for retrieving information recorded on the recording medium; and
a controller coupled to each of the input user-interface, the at least one electronic interface, the recording/retrieving portion, and the display, said controller being responsive to the first user-generated signal for controlling the recording/retrieving portion to cause the recording/retrieving portion to operate in the recording mode in which the combined video information received by the at least one electronic interface is recorded on the recording medium, said controller being responsive to the second user-generated signal for controlling the recording/retrieving portion to cause the recording/retrieving portion to operate in the retrieving mode in which the combined video information is retrieved from the recording medium and forwarded to the display for being displayed at one of the first predetermined frame display rate and the second predetermined frame display rate.

18. A system as set forth in claim 17, wherein the retrieving mode is a search mode in which the recording/retrieving portion retrieves the combined video information from the recording medium at a rate corresponding to the second predetermined frame display, and wherein the combined video information is displayed at the second predetermined frame display rate.

19. A system as set forth in claim 16, wherein the combiner combines the first and second video information by inserting individual ones of the second video frames into at least a portion of corresponding individual ones of the first video frames.

20. A system as set forth in claim 19, wherein the combiner performs the inserting by inserting each individual second video frame as a Picture-In-Picture (PIP) sub-frame into a corresponding first video frame.

21. A user information appliance, comprising:
at least one receiver for receiving broadcast first and second video information, the first and second video information representing first and second video frames, respectively, wherein at least one first program segment is represented by a first number of the first video frames, at least one second program segment is represented by a second number of the second video frames, and the first and second numbers are predetermined to correspond to first and second predetermined frame display rates, respectively; and
a combiner controller, arranged to combine the first and second video information to form combined video information, and for outputting the combined video information to a display apparatus to cause the display apparatus to display at least a portion of the combined video information at one of the first and second predetermined frame display rates.

22. A user information appliance as set forth in claim 21, further comprising:
an input user-interface, operable by a user for generating either a first user-generated signal or a second user-generated signal; and
a recording/retrieving portion, operable in a recording mode for recording information on a storage medium or a retrieving mode for retrieving information from the recording medium,
wherein said combiner controller is responsive to the first user-generated signal for controlling the recording/retrieving portion to cause the recording/retrieving portion to operate in the recording mode in which the first video information received by the at least one receiver is recorded on the recording medium, and said controller is responsive to the second user-generated signal for controlling the recording/retrieving portion to cause the recording/retrieving portion to operate in the retrieving mode in which the first video information is retrieved from the recording medium for then being combined with the second video information to form the combined information

23. A user information appliance as set forth in claim 22, wherein the retrieving mode is a search mode in which the recording/retrieving portion retrieves first video information from the recording medium at a rate corresponding to the second predetermined frame display, and wherein the combined video information is displayed at the second predetermined frame display rate.

24. A user information appliance as set forth in claim 21, wherein the combiner controller combines the first and second video information by inserting individual ones of the second video frames into at least a portion of corresponding individual ones of the first video frames.

25. A user information appliance as set forth in claim 24, wherein the combiner controller performs the inserting by inserting each individual second video frame as a Picture-In-Picture (PIP) sub-frame into a corresponding first video frame.

26. A user information appliance as set forth in claim 24, wherein the second program segment includes advertisement content.

27. A system for communicating video information, comprising:
a transmitter station, comprising:
a storage area for storing at least first and second video information, the first and second video information representing first and second video frames, respectively, wherein at least one first program segment is represented by a first number of the first video frames, at least one second program segment is represented by a second number of the second video frames, and the first and second numbers are predetermined to correspond to first and second predetermined frame display rates, respectively, and
at least one transmitter, arranged to transmit the first and second video information from the transmitter station; and
at least one user information appliance, comprising:
at least one receiver, arranged to receive the first and second video information transmitted from the transmitter station,
at least one electronic interface, arranged to be coupled to a display apparatus, and
a combiner controller, arranged to combine the first and second video information after receipt by the at least one receiver, to form combined video information representing a combination of the first and second video frames, and also arranged to forward the combined information to the display apparatus through the at least one electronic interface, to cause the display apparatus to display at least a portion of the combined information at one of the first predetermined frame display rate and the second predetermined frame display rate.

28. A system as set forth in claim 27, wherein the user information appliance further comprises:
an input user-interface, operable by a user for generating either a first user-generated signal or a second user-generated signal; and
a recording/retrieving portion, operable in a recording mode for recording information on a recording medium or a retrieving mode for retrieving information recorded on the recording medium,
wherein said combiner controller is responsive to the first user-generated signal for controlling the recording/retrieving portion to cause the recording/retrieving portion to operate in the recording mode in which the first video information received by the at least one receiver is recorded on the recording medium, and wherein the combiner controller is responsive to the second user-generated signal for controlling the recording/retrieving portion to cause the recording/retrieving portion to operate in the retrieving mode in which the first video information is retrieved from the recording medium, for then being combined with the second video information to form the combined information

29. A system as set forth in claim 28, wherein the retrieving mode is a search mode in which the recording/retrieving portion retrieves the first video information from the recording medium at a rate corresponding to the second predetermined frame display, and wherein the combined video information is displayed at the second predetermined frame display rate.

30. A system as set forth in claim 28, wherein the combiner controller combines the first and second video information by inserting individual ones of the second video frames into at least a portion of corresponding individual ones of the first video frames.

31. A system as set forth in claim 30, wherein the combiner controller performs the inserting by inserting each individual second video frame as a Picture-In-Picture (PIP) sub-frame into a corresponding first video frame.

32. A system as set forth in claim 28, wherein the second program segment includes advertisement content.

33. A user information appliance, comprising:
a recording/retrieving portion, operable in a recording mode for recording provided first video information on a recording medium or a retrieving mode for retrieving the first video information from the recording medium, the first video information representing first video frames, wherein at least one first program segment is represented by a first number of the first video frames, and the first number is predetermined to correspond to a first predetermined frame display rate; and
a combiner controller coupled to the recording/retrieving portion, said combiner controller arranged to control the recording/retrieving portion to cause the recording/retrieving portion to operate in the retrieving mode in which the first video information is retrieved from the recording medium, and also arranged to combine the retrieved first information with pre-stored second video information to form combined video information, wherein the second video information represents second video frames, at least one second program segment is represented by a second number of the second video frames, and the second number is predetermined to correspond to a second predetermined frame display rate, and wherein the combiner controller further is arranged to output the combined video information to a display apparatus to cause the display apparatus to display at least a portion of the combined information at one of the first and second predetermined frame display rates.

34. A user information appliance as set forth in claim 33, further comprising
an input user-interface, operable by a user for generating either a first user-generated signal or a second user-generated signal, wherein said combiner controller is responsive to the first user-generated signal for controlling the recording/retrieving portion to cause the recording/retrieving portion to operate in the recording mode, and said controller is responsive to the second user-generated signal for controlling the recording/retrieving portion to cause the recording/retrieving portion to operate in the retrieving mode.

35. A user information appliance as set forth in claim 34, wherein the retrieving mode is a search mode in which the recording/retrieving portion retrieves the first video information from the recording medium at a rate corresponding to the second predetermined frame display rate, and wherein the combined video information is displayed at the second predetermined frame display rate.

36. A user information appliance as set forth in claim 34, wherein the combiner controller combines the first and second video information by inserting individual ones of the second video frames into at least a portion of corresponding individual ones of the first video frames.

37. A user information appliance as set forth in claim 36, wherein the combiner performs the inserting by inserting each individual second video frame as a Picture-In-Picture (PIP) sub-frame into a corresponding first video frame.

38. A user information appliance as set forth in claim 37, wherein the second program segment includes advertisement content.

39. A user information appliance, comprising:
a retrieving portion, controllable for retrieving first, video information from a recording medium at either a first predetermined retrieval rate or a second predetermined retrieval rate, the first, video information representing first video frames, wherein at least one first program segment is represented by a first number of the first video frames, and the first number is predetermined to correspond to the first predetermined retrieval rate;
an input user-interface, operable by a user for generating a user-generated signal; and
a controller coupled to said retrieving portion and said input user-interface, said controller being responsive to the user-generated signal for controlling the retrieving portion so as to cause retrieval of the first, video information from the recording medium at the first predetermined retrieval rate, and the forwarding of the retrieved first, video information and second, provided information to a display which displays the first, video information and the second, provided information at a frame display rate corresponding to the first predetermined retrieval rate.

40. A user information appliance as set forth in claim 39, wherein the second, provided information represents second video frames, at least one second program segment is represented by a second number of the second video frames, and the second number is predetermined to correspond to the second predetermined retrieval rate.

41. A user information appliance as set forth in claim 39, wherein the second, provided information represents at least one of text or an image.

42. A user information appliance as set forth in claim 39, wherein the second, provided information is displayed as a subscreen by the display.

43. A user information appliance as set forth in claim 39, wherein the user information appliance is a personal video recorder.
